(19) United States
(12) Patent Application Publication
(10) Pub. No.: US 2026/0226793 A1
(43) Pub. Date: Aug. 6, 2026

(54) METHOD FOR MONITORING A DOOR SYSTEM, MONITORING UNIT AND DOOR CONTROLLER

(71) Applicant: Assa Abloy Entrance Systems AB, Landskrona (SE)

(72) Inventors: Emanuel PONGRATZ, Lippstadt (DE); Konstantin SCHMIDT, Erwitte (DE); Anders STENING, Lippstadt (DE)

(21) Appl. No.: 19/147,904

(22) PCT Filed: Jan. 23, 2024
(86) PCT No.: PCT/EP2024/051515

§ 371 Date: Jul. 14, 2025

(30) Foreign Application Priority Data
Jan. 26, 2023 (SE) 2330050-2

(51) Int. Cl. E06B 9/68

(52) U.S. Cl. CPC E06B 9/68; E06B 2009/6836

(57) ABSTRACT

A method for monitoring the operation of an automatic door system (12) has the steps of:
a. repeatedly receiving messages indicating at least one occurrence of a reverse event of a door (18) of the door system (12) by a monitoring unit (14),
b. associating the at least one occurrence of a reverse event indicated in the message with a timestamp,
c. aggregating the received occurrences of a reverse event based on the respective associated timestamps obtaining an aggregated set of events by the monitoring unit (14), and
d. outputting a signal based on the aggregated set of events by the monitoring unit (14).

Further, a monitoring unit (14), a door controller (22), a system (10) and a computer program are provided.

The invention relates to a method for monitoring the operation of an automatic door system, a monitoring unit for an automatic door system, a door controller for an automatic door system, a system as well as a computer program.

Automatic door systems are used to isolate different areas from another, for example thermally isolate an indoor area from an outdoor area. Further, different production areas within the same building may be isolated from one another in order to avoid cross-contamination (e.g. in food production) or to avoid contamination at all (e.g. of a clean room).

Thus, the doors of such automatic door systems should be in their closed state for as long as possible in order to fulfill their purpose, i.e. as long as no user needs to pass the passageway of the door system.

Potentially problematic situations occur at door systems that are frequently used as it may be necessary for persons or vehicles to pass through the door while the door is in its closing movement. For example, a pedestrian does not wait in front of a closing door until the door starts reversing. In another example, drivers of vehicles, like forklifts or trucks, do not recognize the closing door as such and speed towards the passageway assuming that the door is open.

Thus, it is an object of the invention to provide a method for monitoring a door system in order to increase the safety of the door.

For this purpose, a method for monitoring the operation of an automatic door system is provided. The message comprising the steps of:
a. repeatedly receiving messages indicating at least one occurrence of a reverse event of a door of the door system by a monitoring unit,
b. associating the at least one occurrence of a reverse event indicated in the message with a timestamp,
c. aggregating the received occurrences of a reverse event based on the respective associated timestamps obtaining an aggregated set of events by the monitoring unit, and
d. outputting a signal based on the aggregated set of events by the monitoring unit.

By receiving and aggregating occurrences of reverse events it becomes possible to identify door systems at which such potentially problematic situations are likely to occur, even though the particular door system is not necessarily one of the door systems most frequently used in a building. Once such a door system is identified, the particular door system may be adapted to reduce the likelihood of problematic situations.

In particular, each occurrence is associated with a timestamp.

In order to ensure that a timestamp is present, the timestamp may be included in the message or added by the monitoring unit.

The timestamp may be the timestamp of the message or the timestamp of the time at the reception of message.

If the at least one occurrence of a reverse event is already associated with a timestamp in the message, the step of associating is merely an extraction of the occurrence of a reverse event and its associated timestamp from the message.

In an aspect, the outputted signal is a graphical representation of the aggregated set of events, facilitating analysis of the data.

For example, a reverse event of the door has occurred when, during a closing movement of the door, an object in and/or approaching a safety area of the door system has been detected and the door is reopened due the detection, increasing the safety of the door system further.

The detection may be based on measurements of at least one sensor.

In order to allow a more precise analysis, if an object is detected within the safety area, in particular within the closing plane of the door, the reverse event may be regarded as a hard reverse, and if an object is detected approaching the safety area, the reverse event is regarded as a soft reverse.

In an aspect, the information whether the occurrence of a reverse event is a hard reverse or a soft reverse is part of the message, allowing a more detailed analysis by the monitoring unit.

The information about the occurrence of a hard or soft reverse may be used for aggregation and/or representation of the aggregated set of events.

In an embodiment, the monitoring unit determines, based on the aggregated set of events, whether or not the door system needs to be adapted, in particular wherein the door system determines the number of occurrences of a reverse event within a predetermined time interval and/or during a predetermined count of door cycles and compares the number of occurrences during the time interval or during the count of door cycles, respectively, with a predefined threshold. This way, identifying a door system that needs adaption is further simplified.

For example, adaption is needed if the number of occurrences of reverse events during the time interval or during the count of door cycles exceeds the predefined threshold.

A differentiation between hard and soft reverses is also possible for this determination.

In an embodiment, binning is used to aggregate the received occurrences of a reverse event by sorting the occurrences based on the associated timestamp into bins corresponding to consecutive time intervals. This way, an analysis with respect to time is possible.

In order to provide relevant information to the user, the aggregated set of events may be displayed based on the outputted signal; and/or the time and/or the date of the last occurrence of a reverse event is displayed, in particular by a user terminal.

For example, the aggregated set of events is displayed as a time series.

The user terminal may be a personal computer, a laptop, a tablet, a mobile device or the like.

For universal accessibility, the user terminal may access the monitoring unit using a web interface provided by the monitoring unit.

In an embodiment, the occurrence of a reverse event is detected by a door controller of the door system, wherein the door controller transmits the message indicating the occurrence of a reverse event to the monitoring unit, providing information to the monitoring unit directly from the source of information.

In order to provide up-to-date reports of the status of the door, the door controller may repeatedly transmit the messages indicating the occurrence of a reverse event to the monitoring unit.

In an aspect, the door controller receives measurements from at least one safety sensor of the door system and determines, based on the received measurements, whether an object is in or approaching a safety area of the door system, providing reliable detection of objects onsite.

In particular, the door controller controls the actuator of the door system.

For above mentioned purpose, a monitoring unit for an automatic door system is further provided. The monitoring unit is configured to carry out a method as described above.

The features and advantages described with respect to the method also apply to the monitoring unit and vice versa.

For example, the monitoring unit is a server located remotely from the automatic door system reducing the resources needed onsite.

Further, for above mentioned purpose, a door controller for an automatic door system is provided. The door controller is configured to detect the occurrence of a reverse event and to transmit a message indicating the occurrence of a reverse event to a monitoring unit.

The features and advantages described with respect to the method also apply to the door controller and vice versa.

The door controller is in particular configured to carry out the steps of a method as described above that are carried out by a door controller.

For above mentioned purpose, further a system is provided. The system comprises a monitoring unit as described above and an automatic door system having a door controller, in particular wherein the system is configured to carry out a method as described above.

The features and advantages described with respect to the method, the monitoring unit and/or the door controller also apply to the system and vice versa.

The door controller is, for example, a door controller as described above

In an aspect, the system comprises a user terminal configured to display the aggregated set of events, providing flexible access to the aggregated set of events.

Further, for above mentioned purpose, a computer program is provided comprising instructions which, when the program is executed by a computer, cause the computer to carry out a method as described above.

Further features and advantages will be apparent from the following description as well as the accompanying drawings, to which reference is made. In the drawings:

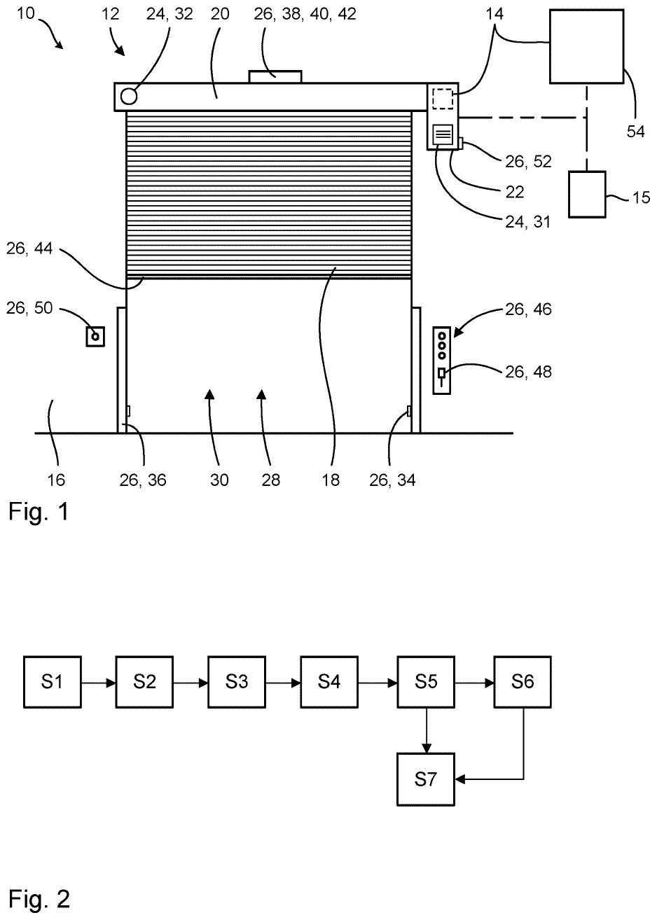

FIG. 1 shows a system according to an embodiment of the invention with a monitoring unit according to an embodiment of the invention and a door controller according to an embodiment of the invention in a schematic view, and

FIG. 2 shows a flowchart of a method according to an embodiment of the invention.

FIG. 1 shows a system 10 having an automatic door system 12, a monitoring unit 14 as well as a user terminal 15.

In the shown embodiment, the automatic door system 12 is located in a building wall 16 to allow access into the building. It is also conceivable that the automatic door system 12 is located in an interior wall 16 to provide separation between different areas within the building itself, for example different production areas to avoid cross-contamination.

The automatic door system 12 is, in the shown embodiment, a high-speed door system having a door 18, an actuator 20, a door controller 22, output means 24 as well as at least one sensor 26.

The actuator 20 is located above the passageway 28 and capable of rolling the door 18 up and down. In the open state of the door 18, the door 18 is rolled up and the passageway 28 is cleared. In the closed state of the door 18, the door 18 is rolled down and the passageway 28 is closed.

The plane in which the door 18 moves up and down is the closing plane being part of a safety area 30 of the door system 12.

The door controller 22 is connected to the actuator 20 and configured to control the actuator 20 so that—by means of the actuator 20—the door controller 22 is configured to control the motion of the door 18 itself.

The output means 24 are also connected to the door controller 22 and configured to be controlled by the door controller 22.

In the shown embodiment, the output means 24 comprise a speaker 31 designed for outputting an acoustic warning and a light 32, in particular a strobe light, designed for outputting a visual warning.

The automatic door system 12 comprises a plurality of sensors 26 connected to the door controller 22, wherein the sensors 26 are configured to monitor the safety area 30 of the door 18 or the vicinity thereof with respect to objects, e.g. persons, vehicles or goods, possibly being located in the passageway 28 and/or is configured to indicate a manual stop or activation command to the door controller 22.

In the shown embodiment, the automatic door system 12 comprises as sensors 26 a photocell 34 and a light curtain 36 located at the bottom of the passageway 28 at either side of the passageway 28 monitoring the closing plane.

Further, in the shown embodiment the automatic door system 12 comprises as sensors 26 an infrared sensor 38, a laser scanner 40 and/or a radar 42 located above the passageway 28, in particular above the actuator 20, and having a field of view downwards at the passageway 28 and in front of the passageway 28 and/or at the back of the passageway 28 to detect objects outside the safety area 30.

It is also conceivable that an infrared sensor, a laser scanner and/or a radar is located below (i.e. in the floor) and/or in the region of the lower half of the passageway 28, having a field of view upwards at the passageway 28 as well as in front of the passageway 28 and/or at the back of the passageway 28.

The sensors 26 provide their measurements to the door controller 22 and the door controller 22 determines, based on the measurements, if an object is in the safety area 30, in particular within the closing plane, or if an object is approaching the safety area 30 to pass through the door.

Further, the door 18, in particular the lower edge of the door 18, is provided with an electromechanical contact sensor 44, namely an electromechanical safety edge, as one of the sensors 26. The contact sensor 44 thus monitors the closing plane physically.

To receive manual commands from users, e.g. a command to open or stop the door 18, the automatic door system 12 comprises as one of the sensors 26 a plurality of control switches 46, a lever 48, in particular an emergency brake release lever, and/or a button 50, in particular an emergency stop button located sideways of the passageway 28.

An interface 52 of the automatic door system 12 to another automatic door system may also constitute a sensor 26 in the case that the two door systems are interlocked, i.e. that only one door of the two door systems may be in the open state at any given time. In this case, the signal about the open or closed state of the other door systems is the sensor input of the interface 52.

The monitoring unit 14 may be part of the door controller 22, as indicated in dashed lines in FIG. 1. In the shown embodiment, the monitoring unit 14 is, however, separate from the door controller 22 and provided as a server 54 remote from the automatic door system 12, in particular a server 54 accessible by the door controller 22 via the internet.

The monitoring unit 14 may run as an application on the server 54.

The user terminal 15 is a device for a user to access the monitoring unit 14 and retrieve information from the monitoring unit 14. This may be done using a web interface provided by the monitoring unit 14 which is accessible by the user terminal 15 via the internet.

The user terminal 15 is, for example, a personal computer, a laptop, a tablet, a mobile device or the like.

During use of the automatic door system 12, the door 18 opens and closes as described above. However, in certain situations, when the door 18 is in its closing movement, an object in and/or approaching the safety area 30 is detected by the door controller 22, which immediately stops the motion of the door 18 and initiates the reverse movement, i.e. an opening movement.

Such an event is called reverse event of the door 18 within this disclosure.

There are two types of reverse events, namely a hard reverse and a soft reverse.

A hard reverse occurs if an object is detected within the safety area 30, i.e. within the closing plane of the door 18. This may be due to a physical contact of the contact sensor 44. Objects, in particular persons, in the safety area 30 during the closing movement of the door 18 produce a safety hazard so that the door 18 is stopped abruptly and reversed immediately by the door controller 22. As such, a hard reverse strains the mechanical parts of the door system 12.

A soft reverse occurs when an object or person is detected approaching the safety area 30 during closing movement of door 18, for example by means of a measurement of the infrared sensor 38 or laser scanner 40. A soft reverse also includes the situation that a person actuates the button 50 or the interface 52. The only difference between a normal opening of the door 18 from its closed state and a soft reverse is that the door 18 is in its closing movement at a soft reverse.

At a soft reverse, the door 18 is stopped as well by the door controller 22 and reopened. However, this action may be performed slower compared to the hard reverse, as there is no immediate danger. As such, the strain on the mechanical parts of the door system 12 is smaller.

In order to monitor the door system 12 for reverse events, the method shown as a flowchart in FIG. 2 is carried out.

The door controller 22 receives the measurements from the sensors 26 and determines the action of the door 18. As such, automatically detects the occurrence of a reverse event (step S1).

In addition to controlling the movement of the door 18, the door controller 22 transmits a message indicating the occurrence of the reverse event to the monitoring unit 14 (step S2).

The door controller 22 transmits messages about the state of the door 18 to the monitoring unit 14 regularly, for example every 10 seconds or immediately.

The messages may include the opening state of the door 18 (open or closed) and information about a reverse event, if such a reverse event has occurred since the last message.

The messages thus do not always include positive information about a reverse event. However, the absence of information about a reverse event may be interpreted as the non-occurrence of a reverse event.

It is also conceivable that the door controller 22 transmits messages to the monitoring unit 14 only after a status change, e.g. after the occurrence of a reverse event.

Thus, the door controller 22 repeatedly transmits messages indicating the occurrence of a reverse event to the monitoring unit 14. “Repeatedly” does not mean that several messages including the same occurrence of a reverse event are sent but rather that messages for different occurrences of a reverse event are sent to the monitoring unit 14.

Further, the message may include information about the reverse event, e.g. whether the reverse event has been a hard reverse or a soft reverse.

It is conceivable that a message includes information about several occurrences of a reverse event, for example if two or more reverse events have occurred in very short succession.

That message may also include a timestamp associated with the occurrence of a reverse event indicating at what time and date the reverse event has occurred. As such, the timestamp is associated with the respective occurrence of the reverse event.

In the case that several occurrences of a reverse event are included in one message, each occurrence may be associated with its own timestamp.

In step S3, the monitoring unit 14 receives the messages sent by the door controller 22. This happens repeatedly as the door controller 22 repeatedly transmits messages.

The monitoring unit 14 thus receives a plurality of messages indicating a plurality of reverse events that have occurred at the door 18.

In step S4, the monitoring unit 14 extracts the occurrences of reverse events from the messages and associates each occurrence with a timestamp.

In case that the message already includes timestamps associated with the occurrences of reverse events, this step is merely the extraction of the occurrences from the message.

If, however, the message does not include timestamps associated with the occurrences, the occurrence indicated in the message is associated with a timestamp by the monitoring unit 14.

For example, the timestamp of the message itself or the time of the reception of the message may be used as a timestamp for the occurrence of the reverse event.

In the next step, step S5, the monitoring unit 14 aggregates the received occurrences of reverse events.

The aggregation is performed based on the timestamp associated with each occurrence of a reverse event. For example, binning is performed by sorting the occurrences based on the associated timestamp into bins corresponding to consecutive time intervals.

For example, each bin corresponds to one hour of the day so that reverse events having an associated timestamp between 8 AM and 9 AM are sorted in the same bin and events with an associated timestamp between 9 AM and 10 PM are sorted in the next bin.

The monitoring unit 14 thus obtains an aggregated set of events.

It is conceivable that other types of aggregation of the received occurrences may be applied.

The aggregation may also be based on further information, like information whether the reverse event has been a hard reverse or a soft reverse, if included in the message.

In step S6, based on the aggregated set of events, the monitoring unit 14 determines whether or not the door system 12 needs to be adapted.

For example, if the number of occurrences of a reverse event in a predetermined time interval (which may or may not correspond to one of the bins used for aggregation) or during a predetermined count of door cycles exceeds a predetermined threshold, it is determined by the monitoring unit 14 that a reverse of the door 18 has to be performed abnormally often and that the door system 12 needs to be adapted in order to reduce the number of reverse events.

For example, the predetermined count of door cycles may be 15 and the threshold may be 8. In this case, if more than 8 reverse events in a set of 15 door cycles occur, it is determined by the monitoring unit 14 that a reverse of the door 18 has to be performed abnormally often.

In this analysis, it may be differentiated between hard reverses and soft reverse as reverse events.

In step S7, a user accesses the monitoring unit 14 using the user terminal 15. The user terminal 15 receives a signal based on the aggregated set of events from the monitoring unit 14, in this case being a graphical representation of the aggregated set of events.

The graphical representation is, for example, a bar chart showing the number of occurrences of reverse events within each bin.

The graphical representation is then displayed on a display means of the user terminal 15.

The graphical representation and more generally the signal from the monitoring unit 14 may differentiate between occurrences of reverse events of a hard reverse and of a soft reverse.

Further, the time and/or date, i.e. the timestamp, of the last occurrence of a reverse event may also be displayed and included in the signal from the monitoring unit 14.

Further, as part of the signal of the monitoring unit 14, the information that the monitoring unit 14 has determined in step S6 that the door system 12 needs to be adapted is transmitted to the user terminal 15. A corresponding information may be displayed in the display means of the user terminal 15.

It is also conceivable that the information that the monitoring unit 14 has determined that the door system 12 needs to be adapted is transmitted to an employee of the manufacturer of the door system 12 as part of the signal based on the aggregated set of events outputted by the monitoring unit 14.

Based on the outputted signal, e.g. the graphical representation, the owner of the door system 12 and/or the manufacturer of the door system 12 are able to identify door systems 12 with many reverse event being door systems 12 at which above mentioned problematic situations are likely to occur.

Measures can then be taken to reduce the number of occurrences of reverse events and with that reduce the number of potentially problematic situations.

For example, new sensors and or detection algorithms in the door controller 22 may be implemented that led to fewer door openings but having the same level of safety and comfort, e.g. by enabling cross-traffic detection. As such, the door is opened less frequently reducing the number of potentially problematic situations.

It is also possible that a different door may be implemented, for example a door that closes faster to reduce the periods of time in which a reverse may occur.

In other cases, adjusting the field of view of one or more of the sensors 26 may also be an adaption to reduce the times that the door is opened unnecessarily.

Thus, the operation of the automatic door system 12 can be monitored closely and countermeasures can be taken to reduce the number of reverse events and potentially problematic situations. This, in turn, increases the safety of the door system 12 and reduces mechanical strain on the components of the door system 12.

1. Method for monitoring the operation of an automatic door system (12), comprising the steps of:
a. repeatedly receiving messages indicating at least one occurrence of a reverse event of a door (18) of the door system (12) by a monitoring unit (14),
b. associating the at least one occurrence of a reverse event indicated in the message with a timestamp,
c. aggregating the received occurrences of a reverse event based on the respective associated timestamps obtaining an aggregated set of events by the monitoring unit (14), and
d. outputting a signal based on the aggregated set of events by the monitoring unit (14).

2. Method according to claim 1, characterized in that the timestamp may be present in the message or added by the monitoring unit (14).

3. Method according to claim 1, characterized in that the outputted signal is a graphical representation of the aggregated set of events.

4. Method according to claim 1, characterized in that a reverse event of the door (18) has occurred when, during a closing movement of the door (18), an object in and/or approaching a safety area (30) of the door system (12) has been detected and the door (18) is reopened due the detection.

5. Method according to claim 4, characterized in that if an object is detected within the safety area (30), in particular a closing plane of the door (18), the reverse event is a hard reverse, and if an object is detected approaching the safety area (30), the reverse event is a soft reverse.

6. Method according to claim 5, characterized in that the information whether the occurrence of a reverse event is a hard reverse or a soft reverse is part of the message.

7. Method according to claim 1, characterized in that the monitoring unit (14) determines, based on the aggregated set of events, whether or not the door system (12) needs to be adapted, in particular wherein the door system (12) determines the number of occurrences of a reverse event within a predetermined time interval and/or during a predetermined count of door cycles and compares the number of occurrences during the time interval or the count of door cycles, respectively, with a predefined threshold.

8. Method according to claim 1, characterized in that binning is used to aggregate the received occurrences of a reverse event by sorting the occurrences based on the associated timestamp into bins corresponding to consecutive time intervals.

9. Method according to a claim 1, characterized in that the aggregated set of events is displayed based on the outputted signal; and/or in that the time and/or date of the last occurrence of a reverse event is displayed, in particular by a user terminal (15).

10. Method according to claim 1, characterized in that the occurrence of a reverse event is detected by a door controller (22) of the door system (12), wherein the door controller (22) transmits the message indicating the occurrence of a reverse event to the monitoring unit (14).

11. Method according to claim 10, characterized in that the door controller (22) receives measurements from at least one sensor (26) of the door system (12) and determines, based on the received measurements, whether an object is in or approaching a safety area (30) of the door system (12).

12. Monitoring unit for an automatic door system (12), wherein the monitoring unit (14) is configured to carry out the method according to claim 1.

13. Monitoring unit according to claim 12, characterized in that the monitoring unit (14) is a server (54) located remotely from the automatic door system (12).

14. Door controller for an automatic door system (12), wherein the door controller (22) is configured to detect the occurrence of a reverse event and to transmit a message indicating the occurrence of a reverse event to a monitoring unit (14).

15. System comprising the monitoring unit (14) according to claim 12 and an automatic door system (12) having a door controller (22).

16. System according to claim 15, characterized in that the system (10) comprises a user terminal (15) configured to display the aggregated set of events.

17. Computer program comprising instructions which, when the program is executed by a computer, cause the computer to carry out the method of claim 1.
